(19) United States
(12) Patent Application Publication
(10) Pub. No.: US 2025/0278448 A1
(43) Pub. Date: Sep. 4, 2025

(54) FRONT-END MICRO-SERVICES THAT PROVIDE DATA CONSISTENCY

(71) Applicant: Capital One Services, LLC, McLean, VA (US)

(72) Inventors: Mark MORRISON, Plano, TX (US); Jason VANDERSLICE, Plano, TX (US); Preetha VEERARAGHAVAN, Plano, TX (US); Erol UNAL, Allen, TX (US)

(21) Appl. No.: 18/593,475

(22) Filed: Mar. 1, 2024

(51) Int. Cl. G06F 16/957

(52) U.S. Cl. CPC G06F 16/9577; G06F 16/9574

(57) ABSTRACT

In some implementations, a user device may receive, from a web host, code associated with at least one webpage. The user device may initiate a plurality of instances of a micro-service using the code. The user device may perform a single application programming interface (API) call for a first instance in the plurality of instances. A response from the single API call is shared with remaining instances in the plurality of instances. The user device may render a plurality of web elements, corresponding to the plurality of instances, using the code and the response from the single API call. The user device may output the at least one webpage, including the plurality of web elements, to a user.

### BACKGROUND

Different webpages may obtain data from a same data source. For example, an aggregator webpage may request data from a same data source as a vendor webpage. However, each webpage may process the data differently, resulting in contradictory data on the different webpages. Additionally, updates to a webpage may trigger new calls to the data source, which results in more network overhead.

### SUMMARY

Some implementations described herein relate to a system for using front-end micro-services in rendering a webpage. The system may include one or more memories and one or more processors communicatively coupled to the one or more memories. The one or more processors may be configured to receive, from a web host, code associated with at least one webpage. The one or more processors may be configured to initiate a plurality of instances of a micro-service using the code. The one or more processors may be configured to perform a single application programming interface (API) call for a first instance in the plurality of instances, wherein a response from the single API call is shared with remaining instances in the plurality of instances. The one or more processors may be configured to render a plurality of web elements, corresponding to the plurality of instances, using the code and the response from the single API call. The one or more processors may be configured to output the at least one webpage, including the plurality of web elements, to a user.

Some implementations described herein relate to a method of using front-end micro-services in rendering a webpage. The method may include receiving, from a user device, a request to access at least one webpage. The method may include initiating, by a web server, a plurality of instances of a micro-service using code associated with the at least one webpage. The method may include performing, by the web server, a single API call for a first instance in the plurality of instances, wherein a response from the single API call is shared with remaining instances in the plurality of instances. The method may include rendering, by the web server, a plurality of web elements, corresponding to the plurality of instances, using the code and the response from the single API call. The method may include transmitting, to the user device, instructions for the at least one webpage including the plurality of web elements that were rendered.

Some implementations described herein relate to a non-transitory computer-readable medium that stores a set of instructions for using front-end micro-services in rendering a webpage. The set of instructions, when executed by one or more processors of a device, may cause the device to receive a request, at an API, from an instance of a micro-service associated with at least one webpage. The set of instructions, when executed by one or more processors of the device, may cause the device to verify that the request is from the instance of the micro-service rather than from a host application associated with the at least one webpage. The set of instructions, when executed by one or more processors of the device, may cause the device to transmit a response to the instance of the micro-service based on verifying that the request is from the instance of the micro-service.

### BRIEF DESCRIPTION OF THE DRAWINGS

FIGS. 1A-1E are diagrams of an example implementation relating to front-end micro-services that provide data consistency, in accordance with some embodiments of the present disclosure.

FIGS. 2A-2G are diagrams of an example implementation relating to front-end micro-services that provide data consistency, in accordance with some embodiments of the present disclosure.

FIG. 3 is a diagram of an example webpage that includes front-end micro-services, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIGS. 6-7 are flowcharts of example processes relating to using front-end micro-services that provide data consistency, in accordance with some embodiments of the present disclosure.

### DETAILED DESCRIPTION

The following detailed description of example implementations refers to the accompanying drawings. The same reference numbers in different drawings may identify the same or similar elements.

Different webpages may obtain data from a same data source. For example, an aggregator webpage may request data from a same data source as a vendor webpage. However, each webpage may process the data differently, resulting in contradictory data on the different webpages. As a result, security is decreased because the data source cannot prevent abuse or misuse of the data by the webpages.

Additionally, updates to a webpage may result trigger new calls to the data source. As a result, network overhead is increased, and power and processing resources are wasted at the data source.

Some implementations described herein enable front-end micro-services on a webpage to perform a single application programming interface (API) call to a data source. The response from the single API call may be shared amongst the micro-services. As a result, network overhead is decreased, and power and processing resources are conserved at the data source. Additionally, the micro-services may deliver data from the response to web elements in a webpage. Because the micro-services deliver the data rather than a host application associated with the webpage, the data is more secure because the host application is unable to tamper with the data. Moreover, the web elements may apply native styles to the data and avoid using shadow document object model (DOM) rendering, which results in the webpage being rendered faster and with less memory overhead.

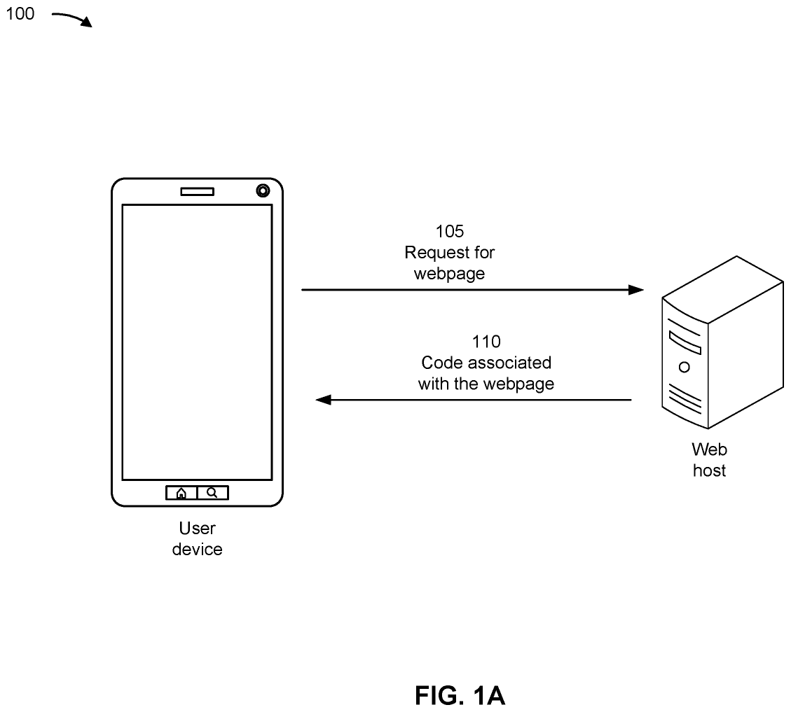

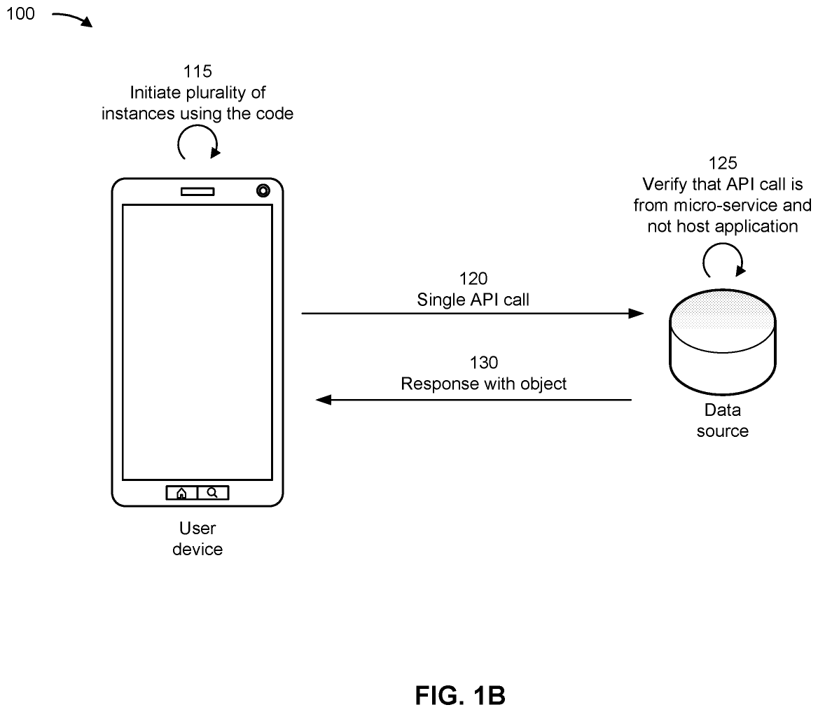

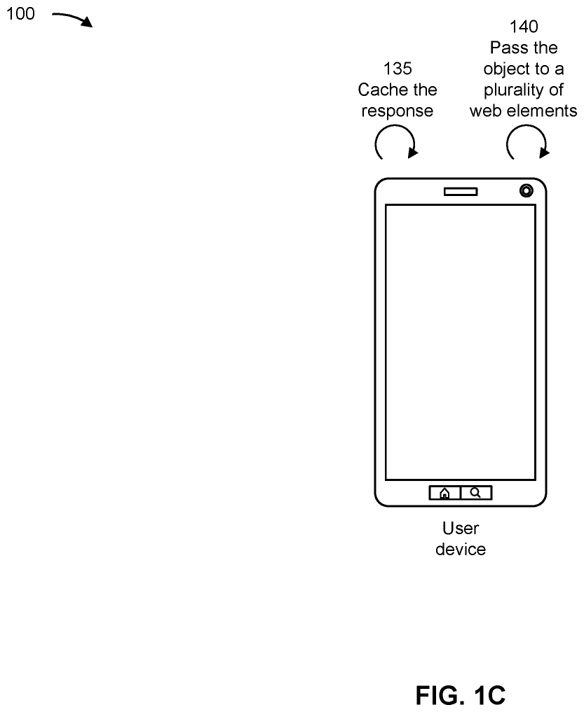

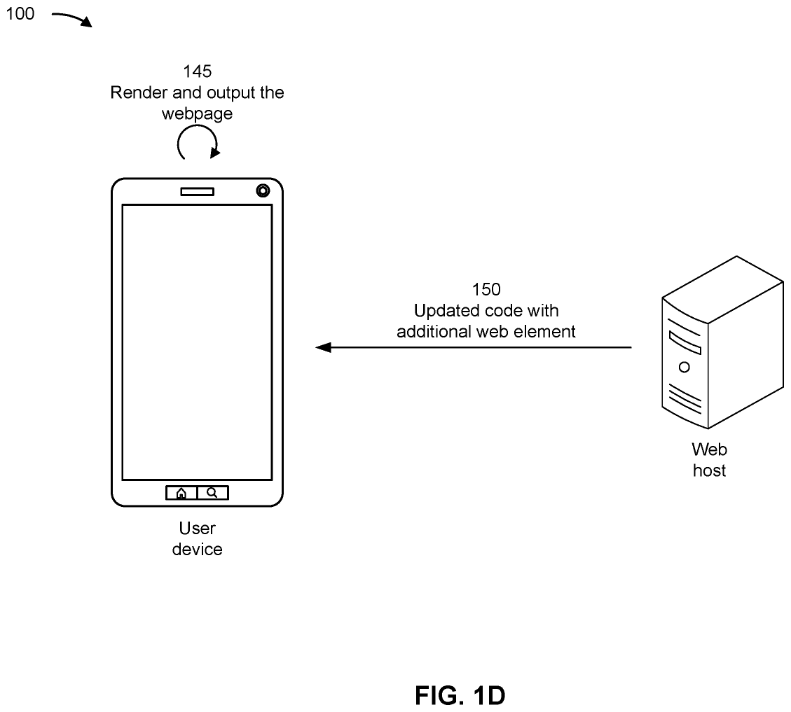

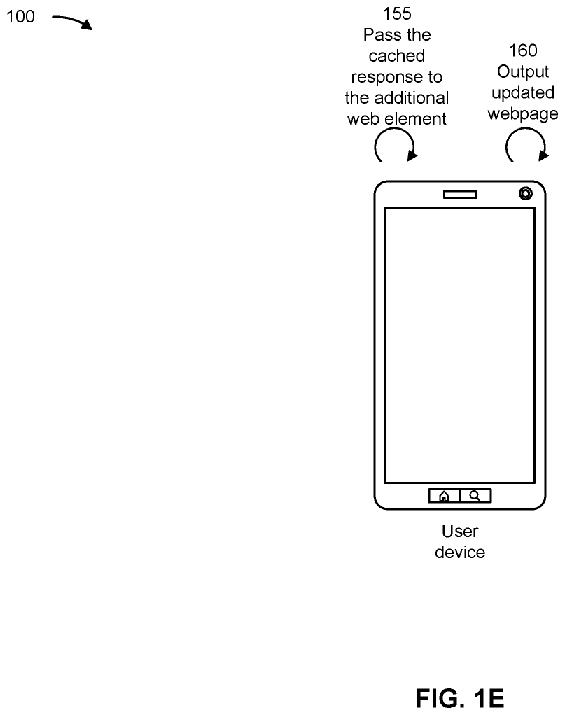

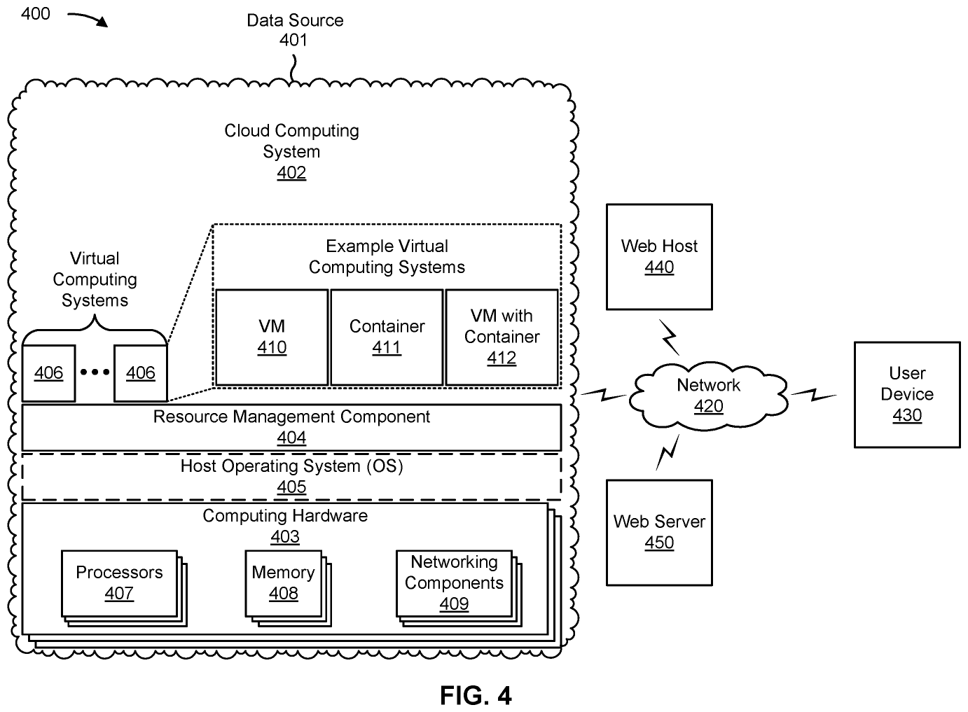

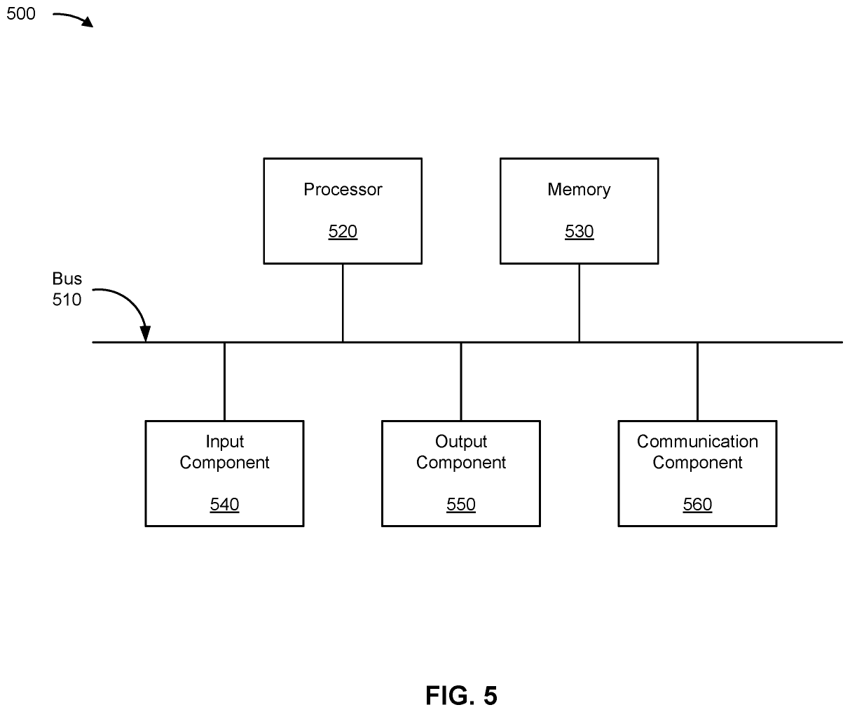

FIGS. 1A-1E are diagrams of an example 100 associated with front-end micro-services that provide data consistency. As shown in FIGS. 1A-1E, example 100 includes a user device, a web host, and a data source. These devices are described in more detail in connection with FIGS. 4 and 5.

As shown in FIG. 1A and by reference number 105, the user device may transmit, and the web host may receive, a request for a webpage (e.g., at least one webpage). The request may include a hypertext transfer protocol (HTTP) request. In some implementations, a user of the user device may provide input (e.g., via an input component of the user device) that triggers a web browser (or another similar type of application) to transmit the request. The input may indicate a uniform resource locator (URL). The web host may be associated with the URL. For example, the user device may resolve the URL (e.g., using a domain name service (DNS) or another type of service) such that the request is addressed to an Internet protocol (IP) address associated with the web host.

Although the example 100 is described in connection with the user device communicating directly with the web host, other examples may include an intermediary device (e.g., at least one intermediary device). For example, the user device may communicate with the web host via one or more network nodes and/or routers (e.g., via the Internet backbone, among other examples) rather than communicating directly.

As shown by reference number 110, the web host may transmit, and the user device may receive, code associated with the webpage. The web host may transmit, and the user device may receive, the code in response to the request from the user device. The code may include JavaScript® code or another type of executable code. Additionally, the code may include hypertext markup language (HTML) code, cascading style sheets (CSS) code, and/or a multimedia file (e.g., an image file and/or a video file), among other examples. Therefore, the user device may render (at least a portion) of the webpage. For example, style instructions (e.g., in an HTML file and/or a CSS file) may be processed along with any text and multimedia included in the code.

As shown in FIG. 1B and by reference number 115, the user device may initiate a plurality of instances of a micro-service using the code. As used herein, “instance” may refer to an executing process instantiated from a program (e.g., the program being the micro-service in this example). Additionally, “micro-service” may refer to a program (e.g., in the code in this example) that communicates over a network (e.g., with the data source, as described below). Herein, the micro-service may be described as “front-end” because the micro-service is executed on a client device (that is, the user device) rather than on a backend (e.g., on the data source or the web host).

The plurality of instances are executed (by the user device) separately from a host application associated with the webpage. In other words, the plurality of instances are able to communicate directly with the data source (or, at least, directly with the web browser and/or an operating system (OS) of the user device that communicates with the data source) rather than communicating through the host application.

As described above, the micro-service may be a program, and instructions for the program may be included in a portion of the code. Therefore, the portion of the code including the instructions may be associated with the plurality of instances. In some implementations, the code may be in a lightweight language, such as JavaScript; therefore, the portion of the code associated with the plurality of instances may be less than 1 kilobyte (kB). As a result, network overhead in transferring the code from the web host to the user device is reduced.

In some implementations, the user device may initiate one instance for every corresponding web element in the webpage. In other words, the user device may initiate the plurality of instances to correspond, on a one-to-one basis, with a plurality of web elements in the webpage. Alternatively, an instance (e.g., at least one instance) in the plurality of instances may be associated with multiple web elements in the webpage. Accordingly, the user device may initiate fewer instances than corresponding web elements.

As shown by reference number 120, the user device may perform a single API call. The single API call may be for a first instance (in the plurality of instances). For example, the user device may perform the single API call based on a race-first system. Accordingly, the first instance (in the plurality of instances) may be associated with an earliest request to an API in a queue. As a result, the earliest request triggers the single API call, and later requests from other instances (in the plurality of instances) are discarded.

As shown by reference number 125, the data source may verify that the request is from the first instance of the micro-service. In other words, the data source may verify that the request is from the micro-service rather than from the host application. For example, the data source may perform verification using a source (e.g., an IP address, a medium access control (MAC) address, a requestor name, and/or another type of alphanumeric identifier associated with the micro-service) indicated in the request. Additionally, or alternatively, the data source may perform verification using a secret code included in the request. For example, the secret code may be hard-coded into the micro-service (e.g., included in the portion of the code associated with the plurality of instances). In another example, the secret code may be generated using a function in a library (e.g., a Java® library, among other examples). In another example, the plurality of instances and the data source may have performed a handshake or otherwise established the secret code before the user device performs the single API call.

Additionally, or alternatively, the data source may verify that the request is not a duplicate. For example, the data source may receive an additional request from an additional instance of the micro-service and may reject the additional request based on the additional request being associated with a same micro-service as the request. Therefore, even if the user device were to inadvertently perform multiple API calls for the plurality of instances, the data source may reject duplicate requests in order to conserve power and processing resources.

As shown by reference number 130, the data source may transmit, and the user device may receive, a response to the single API call. The response may include an object (e.g., at least one object). For example, the response may include a JavaScript object notation (JSON) data structure or another type of object that includes a plurality of elements. Therefore, different instances of the micro-service may use different elements in the object. For example, the first instance uses a first element from the object, and a second instance in the plurality of instances uses a second element, different than the first element, from the object.

The response from the single API call may be shared with remaining instances in the plurality of instances. For example, the first instance may pass the response to the remaining instances. In another example, the user device (e.g., via the OS) may provide the response to the remaining instances based on later requests from the remaining instances, as described above. Therefore, the plurality of instances receive the response with less network overhead and computing resource waste than if the user device were to perform an API call for each instance.

As shown in FIG. 1C and by reference number 135, the user device may cache the response. For example, the user device may generate a cached version of the response from the single API call. Therefore, the user device may provide the cached version to additional web elements (e.g., as described in connection with FIG. 1E).

As shown by reference number 140, the user device may pass portions of the response from the plurality of instances to the plurality of web elements. For example, each instance (in the plurality of instances) may pass elements, in the object of the response, to a corresponding web element (or corresponding web elements) in the plurality of web elements. Therefore, each web element may receive variables (e.g., integers, decimals, strings, and/or other types of variables) that the web element formats and outputs as part of the webpage, as described below.

As shown in FIG. 1D and by reference number 145, the user device may render the plurality of web elements. For example, the user device may render the plurality of web elements using the code and the response from the single API call. The web browser executed by the user device may generate instructions to display the plurality of web elements based on the code, and the plurality of web elements may include content based on the response (e.g., based on elements in the object of the response passed to the plurality of web elements by the plurality of instances).

The user device may render the plurality of web elements according to respective styles of the plurality of web elements. Because the instances pass elements from the object directly to the web elements, each web element may apply native styling to the content based on the response. Therefore, the user device conserves power and processing resources that otherwise would have been spent using shadow DOM rendering for each instance.

As further shown by reference number 145, the user device may output the webpage, including the plurality of web elements, to the user. For example, the user device may use an output component of the user device to output the webpage (e.g., by transmitting instructions for the webpage to the output component).

In some implementations, updates to the webpage may be rendered without additional API calls. For example, as shown by reference number 150, the web host may transmit, and the user device may receive, updated code associated with the webpage. The web host may transmit, and the user device may receive, the updated code in response to a request from the user device or in response to determining that the webpage has been updated. The updated code may define an additional web element. Accordingly, as shown in FIG. 1E and by reference number 155, the user device may pass (at least a portion of) the cached version of the response to the additional web element. For example, the user device may initiate a new instance of the micro-service, corresponding to the additional web element, and may provide the cached version of the response to the new instance. Therefore, the additional web element may receive, from the new instance, a variable (e.g., at least one variable) from the object of the response that the additional web element format and outputs as part of an updated version of the webpage. As shown by reference number 160, the user device may output the updated version of the webpage, including the additional web element, to the user.

By using techniques as described in connection with FIGS. 1A-1E, the user device performs the single API call on behalf of the plurality of instances. The response from the single API call is shared amongst the plurality of instances. As a result, network overhead is decreased, and power and processing resources are conserved at the data source. Additionally, the plurality of instances deliver data from the response directly to the plurality of web elements, which increases security because the host application is unable to tamper with the data. Moreover, the plurality of web elements may apply native styles to the data and avoid using shadow DOM rendering, which results in the webpage being rendered faster and with less memory overhead.

As indicated above, FIGS. 1A-1E are provided as an example. Other examples may differ from what is described with regard to FIGS. 1A-1E.

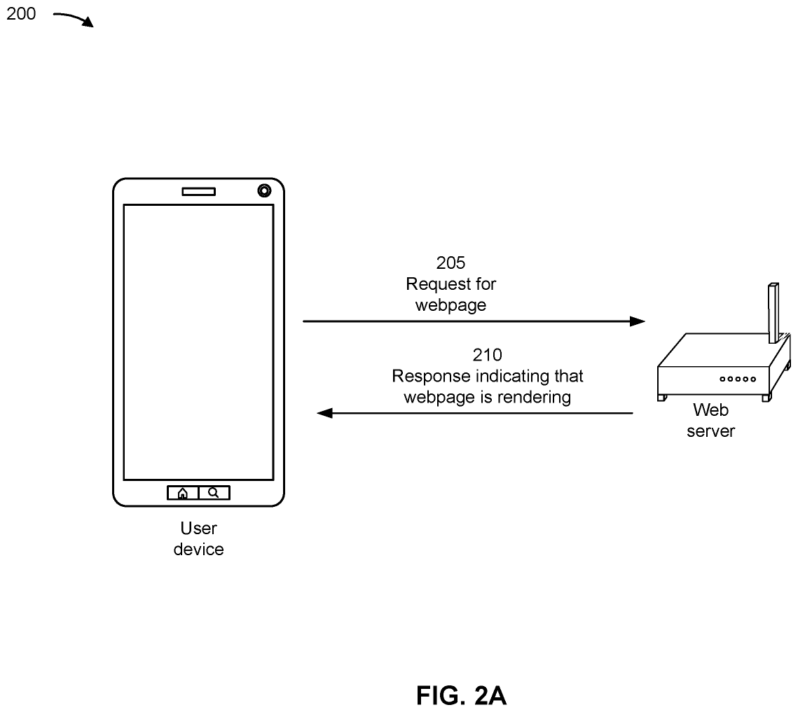

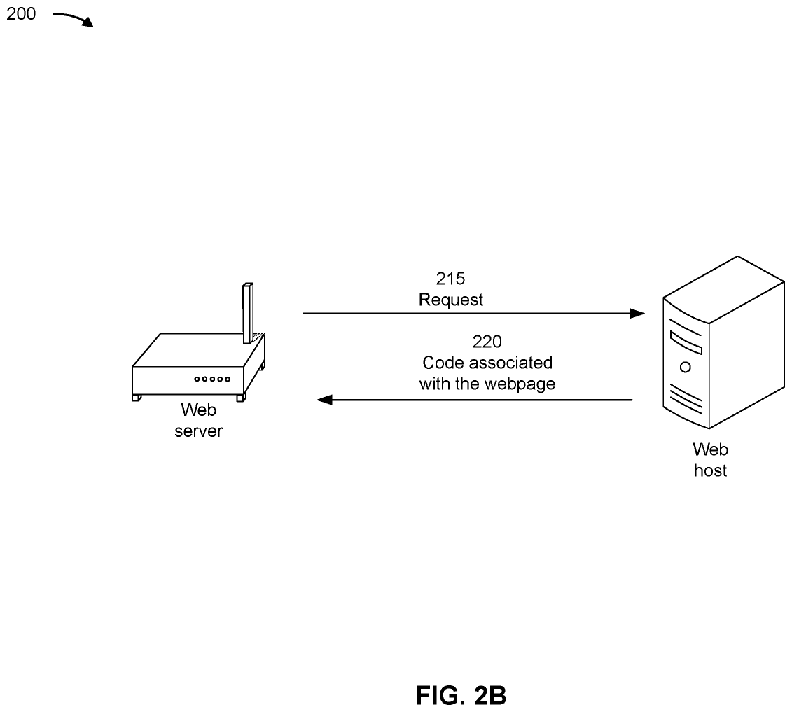

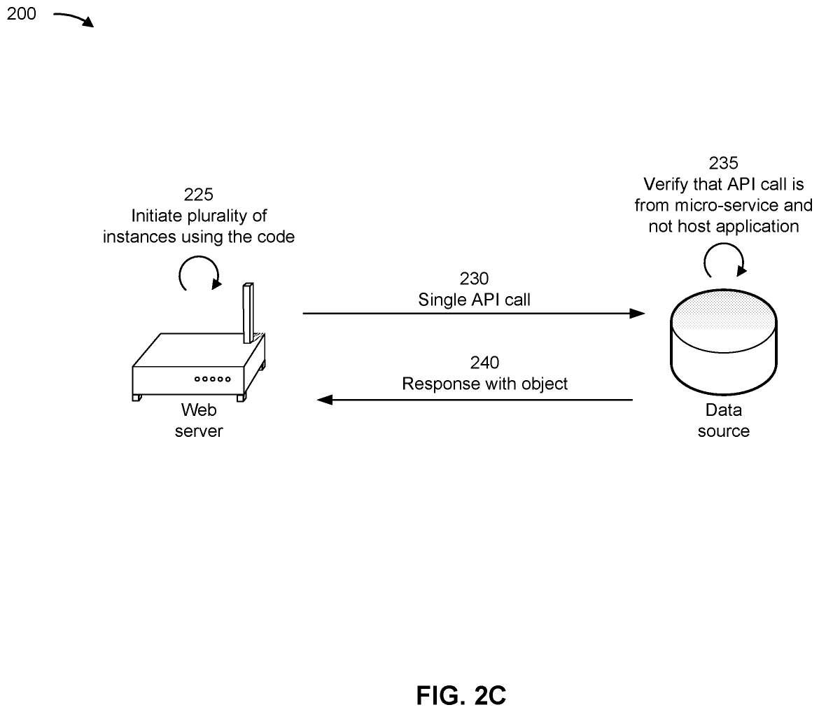

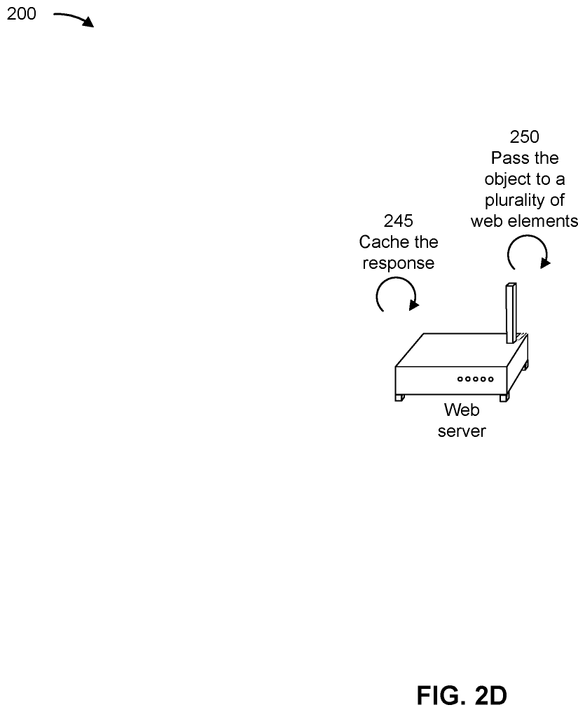

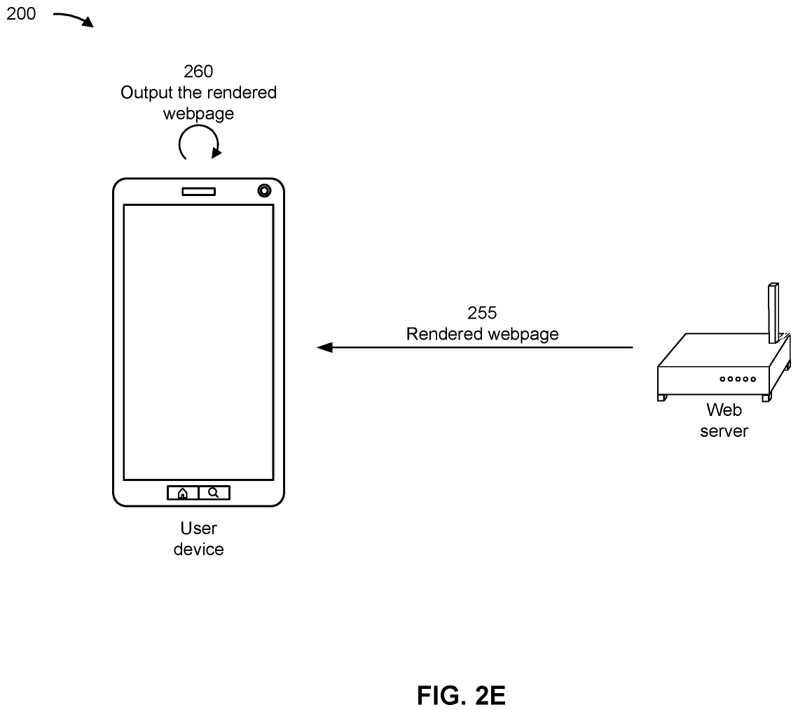

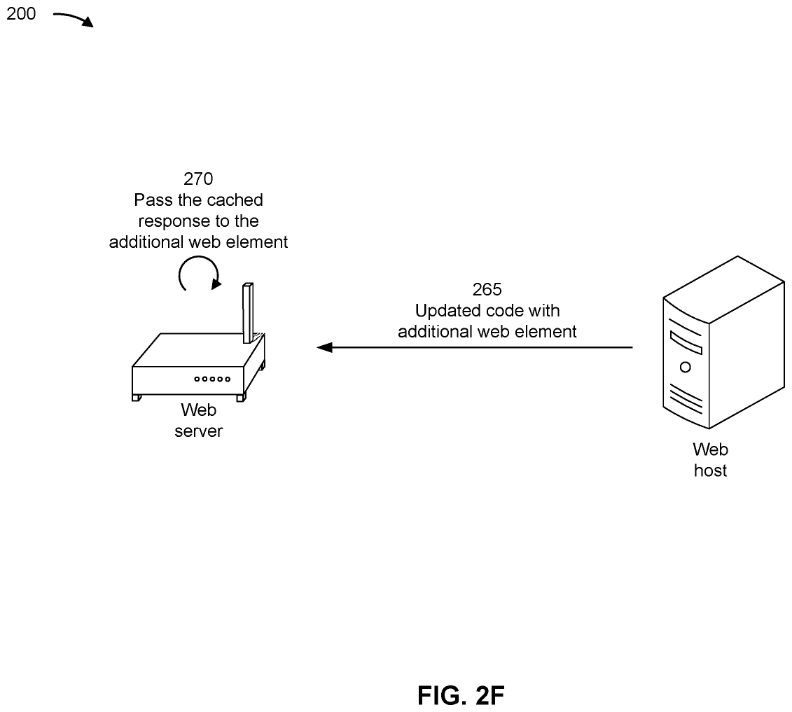

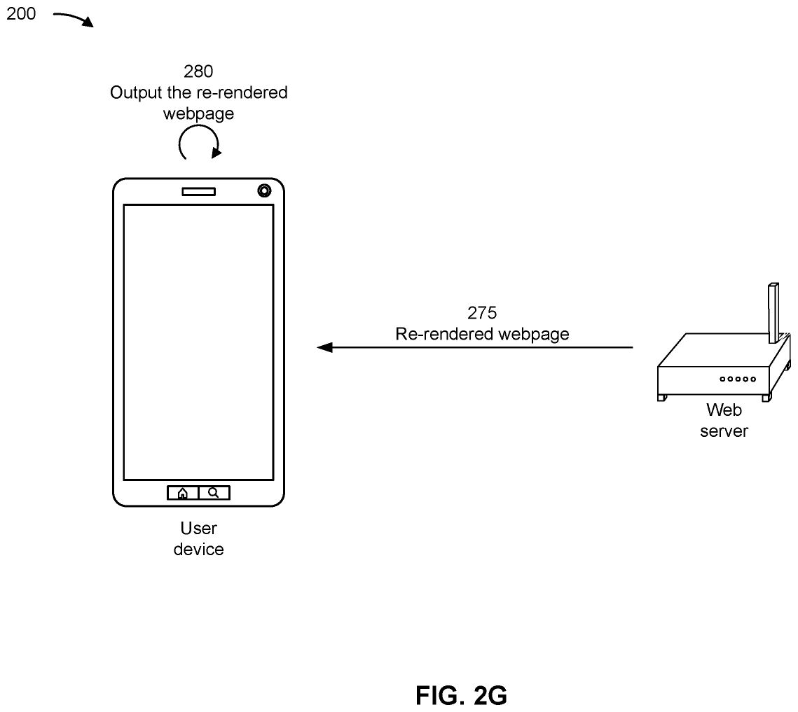

FIGS. 2A-2G are diagrams of an example 200 associated with front-end micro-services that provide data consistency. As shown in FIGS. 2A-2G, example 200 includes a user device, a web server, a web host, and a data source. These devices are described in more detail in connection with FIGS. 4 and 5.

As shown in FIG. 2A and by reference number 205, the user device may transmit, and the web server may receive, a request for a webpage (e.g., at least one webpage). The request may include an HTTP request. In some implementations, a user of the user device may provide input (e.g., via an input component of the user device) that triggers a web browser (or another similar type of application) to transmit the request. The input may indicate a URL. The web server may be associated with the URL. For example, the user device may resolve the URL (e.g., using a DNS or another type of service) such that the request is addressed to an IP address associated with the web server.

Although the example 100 is described in connection with the user device communicating directly with the web server, other examples may include an intermediary device (e.g., at least one intermediary device). For example, the user device may communicate with the web server via one or more network nodes and/or routers (e.g., via the Internet backbone, among other examples) rather than communicating directly.

As shown by reference number 210, the web server may transmit, and the user device may receive, a response indicating that the webpage is rendering. For example, the web server may render the webpage and provide the rendered webpage to the user device for output (e.g., as described in connection with FIG. 2E). Therefore, the user device may output (e.g., using an output component of the user device) a loading screen, an hourglass icon, and/or another indicator of loading based on the response indicating that the webpage is rendering.

As shown in FIG. 2B and by reference number 215, the web server may transmit, and the web host may receive, a request for the webpage. The request may include an HTTP request. In some implementations, the web server may forward the request from the user device directly to the web host. Alternatively, the web server may decode the request from the user device and generate a new request to the web host based on information decoded from the user device's request.

As shown by reference number 220, the web host may transmit, and the web server may receive, code associated with the webpage. The web host may transmit, and the web server may receive, the code in response to the request from the web server. The code may include JavaScript code or another type of executable code. Additionally, the code may include HTML code, CSS code, and/or a multimedia file (e.g., an image file and/or a video file), among other examples. Therefore, the web server may render (at least a portion) of the webpage. For example, style instructions (e.g., in an HTML file and/or a CSS file) may be processed along with any text and multimedia included in the code.

As shown in FIG. 2C and by reference number 225, the web server may initiate a plurality of instances of a micro-service using the code. Herein, the micro-service may be described as “front-end” because the micro-service is executed on a client device (that is, the web server) rather than on a backend (e.g., on the data source or the web host). The plurality of instances are executed (by the web server) separately from a host application associated with the webpage. In other words, the plurality of instances are able to communicate directly with the data source (or, at least, directly with an OS of the web server that communicates with the data source) rather than communicating through the host application.

As described above, the micro-service may be a program, and instructions for the program may be included in a portion of the code. Therefore, the portion of the code including the instructions may be associated with the plurality of instances. In some implementations, the code may be in a lightweight language, such as JavaScript; therefore, the portion of the code associated with the plurality of instances may be less than 1 kB. As a result, network overhead in transferring the code from the web host to the web server is reduced.

In some implementations, the web server may initiate one instance for every corresponding web element in the webpage. In other words, the web server may initiate the plurality of instances to correspond, on a one-to-one basis, with a plurality of web elements in the webpage. Alternatively, an instance (e.g., at least one instance) in the plurality of instances may be associated with multiple web elements in the webpage. Accordingly, the web server may initiate fewer instances than corresponding web elements.

As shown by reference number 230, the web server may perform a single API call. The single API call may be for a first instance (in the plurality of instances). For example, the web server may perform the single API call based on a race-first system. Accordingly, the first instance (in the plurality of instances) may be associated with an earliest request to an API in a queue. As a result, the earliest request triggers the single API call, and later requests from other instances (in the plurality of instances) are discarded.

As shown by reference number 235, the data source may verify that the request is from the first instance of the micro-service. In other words, the data source may verify that the request is from the micro-service rather than from the host application. For example, the data source may perform verification using a source (e.g., an IP address, a MAC address, a requestor name, and/or another type of alphanumeric identifier associated with the micro-service) indicated in the request. Additionally, or alternatively, the data source may perform verification using a secret code included in the request. For example, the secret code may be hard-coded into the micro-service (e.g., included in the portion of the code associated with the plurality of instances). In another example, the secret code may be generated using a function in a library (e.g., a Java library, among other examples). In another example, the plurality of instances and the data source may have performed a handshake or otherwise established the secret code before the web server performs the single API call.

Additionally, or alternatively, the data source may verify that the request is not a duplicate. For example, the data source may receive an additional request from an additional instance of the micro-service and may reject the additional request based on the additional request being associated with a same micro-service as the request. Therefore, even if the web server were to inadvertently perform multiple API calls for the plurality of instances, the data source may reject duplicate requests in order to conserve power and processing resources.

As shown by reference number 240, the data source may transmit, and the web server may receive, a response to the single API call. The response may include an object (e.g., at least one object). For example, the response may include a JSON data structure or another type of object that includes a plurality of elements. Therefore, different instances of the micro-service may use different elements in the object. For example, the first instance uses a first element from the object, and a second instance in the plurality of instances uses a second element, different than the first element, from the object.

The response from the single API call may be shared with remaining instances in the plurality of instances. For example, the first instance may pass the response to the remaining instances. In another example, the web server (e.g., via the OS) may provide the response to the remaining instances based on later requests from the remaining instances, as described above. Therefore, the plurality of instances receive the response with less network overhead and computing resource waste than if the web server were to perform an API call for each instance.

As shown in FIG. 2D and by reference number 245, the web server may cache the response. For example, the web server may generate a cached version of the response from the single API call. Therefore, the web server may provide the cached version to additional web elements (e.g., as described in connection with FIG. 2F).

As shown by reference number 250, the web server may pass portions of the response from the plurality of instances to the plurality of web elements. For example, each instance (in the plurality of instances) may pass elements, in the object of the response, to a corresponding web element (or corresponding web elements) in the plurality of web elements. Therefore, each web element may receive variables (e.g., integers, decimals, strings, and/or other types of variables) that the web element formats and outputs as part of the webpage, as described below.

The web server may render the plurality of web elements. For example, the web server may render the plurality of web elements using the code and the response from the single API call. The web server may generate HTML code based on rendering the plurality of web elements that include content based on the response (e.g., based on elements in the object of the response passed to the plurality of web elements by the plurality of instances).

The web server may render the plurality of web elements according to respective styles of the plurality of web elements. Because the instances pass elements from the object directly to the web elements, each web element may apply native styling to the content based on the response. Therefore, the web server conserves power and processing resources that otherwise would have been spent using shadow DOM rendering for each instance.

As shown in FIG. 2E and by reference number 255, the web server may transmit, and the user device may receive, a rendered version of the webpage including the plurality of web elements. As shown by reference number 260, the user device may output the rendered version of the webpage to the user. For example, the user device may use an output component of the user device to output the rendered version of the webpage.

In some implementations, updates to the webpage may be rendered without additional API calls. For example, as shown in FIG. 2F and by reference number 265, the web host may transmit, and the web server may receive, updated code associated with the webpage. The web host may transmit, and the web server may receive, the updated code in response to a request from the web server or in response to determining that the webpage has been updated. The updated code may define an additional web element. Accordingly, as shown by reference number 270, the web server may pass (at least a portion of) the cached version of the response to the additional web element. For example, the web server may initiate a new instance of the micro-service, corresponding to the additional web element, and may provide the cached version of the response to the new instance. Therefore, the additional web element may receive, from the new instance, a variable (e.g., at least one variable) from the object of the response that the additional web element format and outputs as part of a re-rendered version of the webpage. As shown in FIG. 2G and by reference number 275, the web server may transmit, and the user device may receive, the re-rendered version of the webpage including the additional web element. As shown by reference number 280, the user device may output the re-rendered version of the webpage to the user.

By using techniques as described in connection with FIGS. 2A-2G, the web server performs the single API call on behalf of the plurality of instances. The response from the single API call is shared amongst the plurality of instances. As a result, network overhead is decreased, and power and processing resources are conserved at the data source. Additionally, the plurality of instances deliver data from the response directly to the plurality of web elements, which increases security because the host application is unable to tamper with the data. Moreover, the plurality of web elements may apply native styles to the data and avoid using shadow DOM rendering, which results in the webpage being rendered faster and with less memory overhead.

As indicated above, FIGS. 2A-2G are provided as an example. Other examples may differ from what is described with regard to FIGS. 2A-2G.

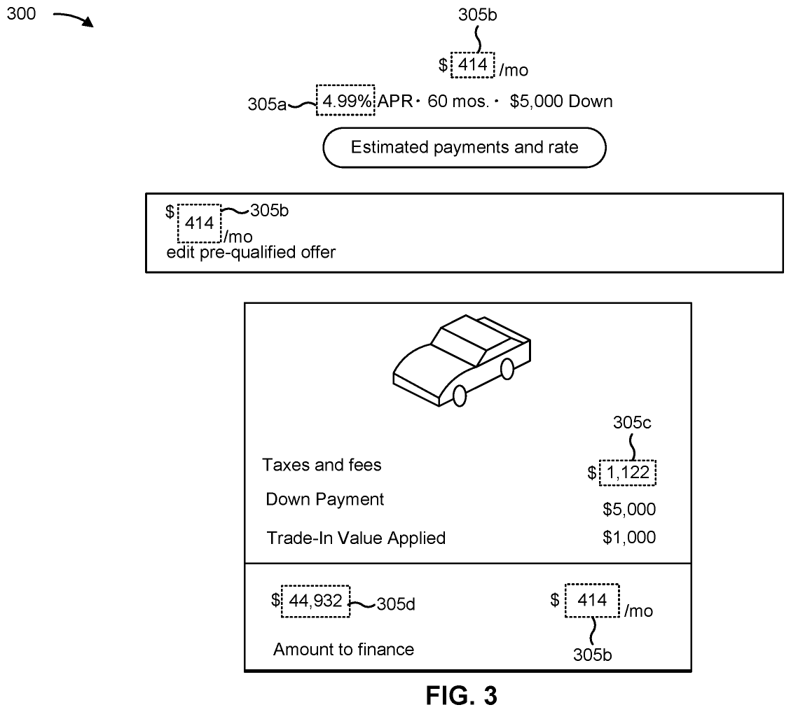

FIG. 3 is a diagram of an example webpage 300 that includes front-end micro-services. The example webpage 300 may be output by a user device, which is described in more detail in connection with FIGS. 4 and 5.

A response from an API call (e.g., as described in connection with FIG. 1B or FIG. 2C) may include an object with a plurality of variables. For example, the object may include variable 305a, variable 305b, variable 305c, and variable 305d. As shown in FIG. 3, a first instance of a micro-service passes the variable 305a to a corresponding web element. Additionally, a second instance, a third instance, and a fourth instance of the micro-service each pass the variable 305b to a corresponding web element. Therefore, the variable 305b is used across three web elements in the example webpage 300.

As further shown in FIG. 3, a fifth instance of the micro-service passes the variable 305c to a corresponding web element, and a sixth instance of the micro-service passes the variable 305d to a corresponding web element. Therefore, the host application is unable to modify the variables 305a, 305b, 305c, or 305d before the web elements format the variables and are rendered. Although the example webpage 300 is described with a one-to-one relationship between instances and web elements, other examples may include an instance (e.g., at least one instance) that corresponds to multiple web elements.

As indicated above, FIG. 3 is provided as an example. Other examples may differ from what is described with regard to FIG. 3. For example, additional variables (e.g., four variables, five variables, and so on) may be included in the response. Alternatively, fewer variables (e.g., three variables, two variables, or one variable) may be included in the response.

FIG. 4 is a diagram of an example environment 400 in which systems and/or methods described herein may be implemented. As shown in FIG. 4, environment 400 may include a data source 401, which may include one or more elements of and/or may execute within a cloud computing system 402. The cloud computing system 402 may include one or more elements 403-412, as described in more detail below. As further shown in FIG. 4, environment 400 may include a network 420, a user device 430, a web host 440, and/or a web server 450. Devices and/or elements of environment 400 may interconnect via wired connections and/or wireless connections.

The cloud computing system 402 may include computing hardware 403, a resource management component 404, a host OS 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the data source 401 may include one or more elements 403-412 of the cloud computing system 402, may execute within the cloud computing system 402, and/or may be hosted within the cloud computing system 402, in some implementations, the data source 401 may not be cloud-based (e.g., may be implemented outside of a cloud computing system) or may be partially cloud-based. For example, the data source 401 may include one or more devices that are not part of the cloud computing system 402, such as device 500 of FIG. 5, which may include a standalone server or another type of computing device. The data source 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device 430 may include one or more devices capable of receiving, generating, storing, processing, and/or providing information associated with webpages, as described elsewhere herein. The user device 430 may include a communication device and/or a computing device. For example, the user device 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 430 may communicate with one or more other devices of environment 400, as described elsewhere herein.

The web host 440 may include one or more devices capable of receiving, generating, storing, processing, and/or providing code associated with webpages, as described elsewhere herein. The web host 440 may include a communication device and/or a computing device. For example, the web host 440 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The web host 440 may communicate with one or more other devices of environment 400, as described elsewhere herein.

The web server 450 may include one or more devices capable of receiving, generating, storing, processing, providing, and/or routing information associated with rendered webpages, as described elsewhere herein. The web server 450 may include a communication device and/or a computing device. For example, the web server 450 may include a server, such as an application server, a client server, a web server, a database server, a host server, a proxy server, a virtual server (e.g., executing on computing hardware), or a server in a cloud computing system. In some implementations, the web server 450 may include computing hardware used in a cloud computing environment. The web server 450 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with front-end micro-services that provide data consistency. The device 500 may correspond to a user device 430, a web host 440, and/or a web server 450. In some implementations, a user device 430, a web host 440, and/or a web server 450 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

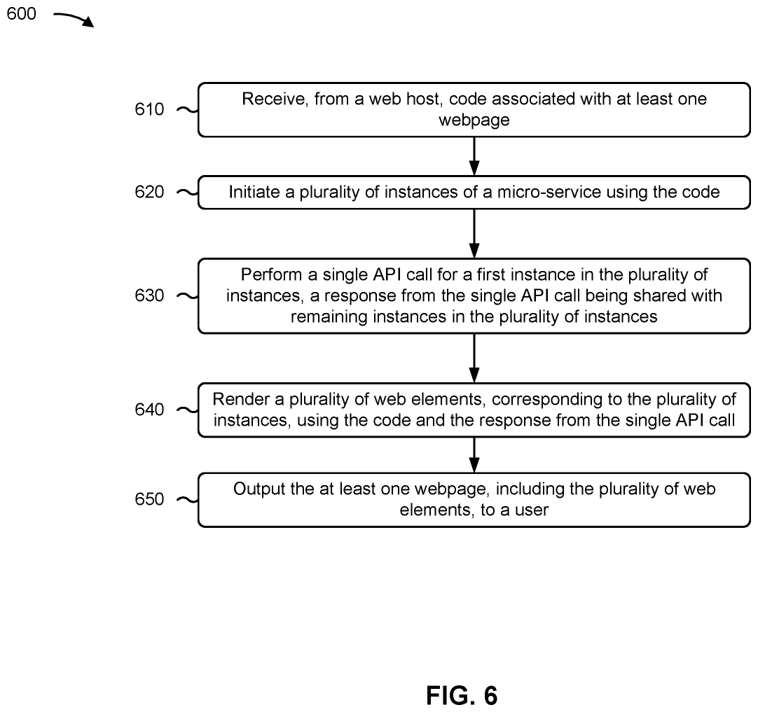

FIG. 6 is a flowchart of an example process 600 associated with using front-end micro-services that provide data consistency. In some implementations, one or more process blocks of FIG. 6 may be performed by a user device 430. In some implementations, one or more process blocks of FIG. 6 may be performed by another device or a group of devices separate from or including the user device 430, such as a data source 401, a web host 440, and/or a web server 450. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a web host, code associated with at least one webpage (block 610). For example, the user device 430 (e.g., using processor 520, memory 530, and/or communication component 560) may receive, from a web host, code associated with at least one webpage, as described above in connection with reference number 110 of FIG. 1A. As an example, the user device 430 may transmit, to the web host, a request for the at least one webpage. The request may include an HTTP request. The user device 430 may receive, from the web host, the code associated with the at least one webpage in response to the request from the user device 430. The code may include JavaScript code or another type of executable code. Additionally, the code may include HTML code, CSS code, and/or a multimedia file (e.g., an image file and/or a video file), among other examples.

As further shown in FIG. 6, process 600 may include initiating a plurality of instances of a micro-service using the code (block 620). For example, the user device 430 (e.g., using processor 520 and/or memory 530) may initiate a plurality of instances of a micro-service using the code, as described above in connection with reference number 115 of FIG. 1B. As an example, the plurality of instances are executed (by the user device 430) separately from a host application associated with the at least one webpage. In other words, the plurality of instances are able to perform API calls directly (or, at least, through a web browser and/or an OS of the user device 430) rather than through the host application.

As further shown in FIG. 6, process 600 may include performing a single API call for a first instance in the plurality of instances, a response from the single API call being shared with remaining instances in the plurality of instances (block 630). For example, the user device 430 (e.g., using processor 520, memory 530, and/or communication component 560) may perform a single API call for a first instance in the plurality of instances, a response from the single API call being shared with remaining instances in the plurality of instances, as described above in connection with reference numbers 120 and 130 of FIG. 1B. As an example, the user device 430 may perform the single API call based on an earliest request to an API in a queue. As a result, the earliest request triggers the single API call, and the user device 430 discards later requests from other instances (in the plurality of instances). The response may include at least one object that includes a plurality of elements. The user device 430 may share the response from the single API call with the remaining instances in the plurality of instances. For example, the first instance may pass the response to the remaining instances. In another example, the user device 430 (e.g., via the web browser and/or the OS) may provide the response to the remaining instances based on the later requests from the remaining instances.

As further shown in FIG. 6, process 600 may include rendering a plurality of web elements, corresponding to the plurality of instances, using the code and the response from the single API call (block 640). For example, the user device 430 (e.g., using processor 520 and/or memory 530) may render a plurality of web elements, corresponding to the plurality of instances, using the code and the response from the single API call, as described above in connection with reference number 145 of FIG. 1D. As an example, the web browser executed by the user device 430 may generate instructions to display the plurality of web elements based on the code, and the plurality of web elements may include content based on the response (e.g., based on elements in the object of the response passed to the plurality of web elements by the plurality of instances). The user device 430 may render the plurality of web elements according to respective styles of the plurality of web elements. Because the plurality of instances pass elements from the object directly to the plurality of web elements, each web element may apply native styling to the content based on the response.

As further shown in FIG. 6, process 600 may include outputting the at least one webpage, including the plurality of web elements, to a user (block 650). For example, the user device 430 (e.g., using processor 520, memory 530, and/or output component 550) may output the at least one webpage, including the plurality of web elements, to a user, as described above in connection with reference number 145 of FIG. 1D. As an example, the user device 430 may use an output component to output the at least one webpage visually and/or auditorily.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E and/or FIG. 3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

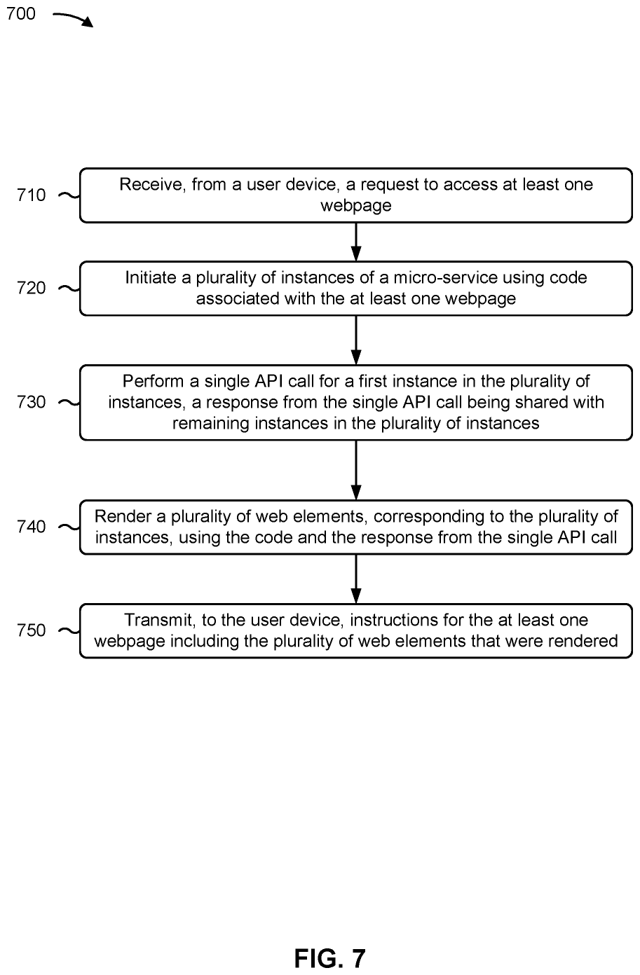

FIG. 7 is a flowchart of an example process 700 associated with using front-end micro-services that provide data consistency. In some implementations, one or more process blocks of FIG. 7 may be performed by a web server 450. In some implementations, one or more process blocks of FIG. 7 may be performed by another device or a group of devices separate from or including the web server 450, such as a data source 401, a user device 430, and/or a web host 440. Additionally, or alternatively, one or more process blocks of FIG. 7 may be performed by one or more components of the device 500, such as processor 520, memory 530, input component 540, output component 550, and/or communication component 560.

As shown in FIG. 7, process 700 may include receiving, from a user device, a request to access at least one webpage (block 710). For example, the web server 450 (e.g., using processor 520, memory 530, and/or communication component 560) may receive, from a user device, a request to access at least one webpage, as described above in connection with reference number 205 of FIG. 2A. As an example, the web server 450 may receive, from the user device, a request for the at least one webpage. The request may include an HTTP request. In some implementations, the request may be associated with a URL that is also associated with the web server 450.

As further shown in FIG. 7, process 700 may include initiating a plurality of instances of a micro-service using code associated with the at least one webpage (block 720). For example, the web server 450 (e.g., using processor 520 and/or memory 530) may initiate a plurality of instances of a micro-service using code associated with the at least one webpage, as described above in connection with reference number 225 of FIG. 2C. As an example, the plurality of instances are executed (by the web server 450) separately from a host application associated with the at least one webpage. In other words, the plurality of instances are able to perform API calls directly (or, at least, through an OS of the web server 450) rather than through the host application.

As further shown in FIG. 7, process 700 may include performing a single API call for a first instance in the plurality of instances, a response from the single API call being shared with remaining instances in the plurality of instances (block 730). For example, the web server 450 (e.g., using processor 520, memory 530, and/or communication component 560) may perform a single API call for a first instance in the plurality of instances, a response from the single API call being shared with remaining instances in the plurality of instances, as described above in connection with reference numbers 230 and 240 of FIG. 2C. As an example, the web server 450 may perform the single API call based on an earliest request to an API in a queue. As a result, the earliest request triggers the single API call, and the web server 450 discards later requests from other instances (in the plurality of instances). The response may include at least one object that includes a plurality of elements. The web server 450 may share the response from the single API call with the remaining instances in the plurality of instances. For example, the first instance may pass the response to the remaining instances. In another example, the web server 450 (e.g., via the OS) may provide the response to the remaining instances based on the later requests from the remaining instances.

As further shown in FIG. 7, process 700 may include rendering a plurality of web elements, corresponding to the plurality of instances, using the code and the response from the single API call (block 740). For example, the web server 450 (e.g., using processor 520 and/or memory 530) may render a plurality of web elements, corresponding to the plurality of instances, using the code and the response from the single API call, as described above in connection with FIG. 2E. As an example, the web server 450 may generate instructions to display the plurality of web elements based on the code, and the plurality of web elements may include content based on the response (e.g., based on elements in the object of the response passed to the plurality of web elements by the plurality of instances). The web server 450 may render the plurality of web elements according to respective styles of the plurality of web elements. Because the plurality of instances pass elements from the object directly to the plurality of web elements, each web element may apply native styling to the content based on the response.

As further shown in FIG. 7, process 700 may include transmitting, to the user device, instructions for the at least one webpage including the plurality of web elements that were rendered (block 750). For example, the web server 450 (e.g., using processor 520, memory 530, and/or communication component 560) may transmit, to the user device, instructions for the at least one webpage including the plurality of web elements that were rendered, as described above in connection with reference number 255 of FIG. 2E. As an example, the web server 450 may transmit HTML code based on rendering the plurality of web elements that include content based on the response (e.g., based on elements in the object of the response passed to the plurality of web elements by the plurality of instances).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 2A-2G and/or FIG. 3. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using front-end micro-services in rendering a webpage, the system comprising:
one or more memories; and
one or more processors, communicatively coupled to the one or more memories, configured to:
receive, from a web host, code associated with at least one webpage;
initiate a plurality of instances of a micro-service using the code;
perform a single application programming interface (API) call for a first instance in the plurality of instances, wherein a response from the single API call is shared with remaining instances in the plurality of instances;
render a plurality of web elements, corresponding to the plurality of instances, using the code and the response from the single API call; and
output the at least one webpage, including the plurality of web elements, to a user.

2. The system of claim 1, wherein the plurality of instances are executed separately from a host application associated with the at least one webpage.

3. The system of claim 1, wherein a portion of the code associated with the plurality of instances is less than 1 kilobyte.

4. The system of claim 1, wherein the one or more processors are configured to:
receive the response from the single API call,
wherein the response includes an object, the first instance uses a first element from the object, and a second instance in the plurality of instances uses a second element, different than the first element, from the object.

5. The system of claim 1, wherein the one or more processors, to render the plurality of web elements, are configured to:
pass portions of the response from the plurality of instances to the plurality of web elements; and
render the plurality of web elements according to respective styles of the plurality of web elements.

6. The system of claim 1, wherein the first instance in the plurality of instances is associated with an earliest request to an API in a queue, and the earliest request triggers the single API call.

7. The system of claim 1, wherein the code comprises JavaScript code.

8. A method of using front-end micro-services in rendering a webpage, comprising:
receiving, from a user device, a request to access at least one webpage;
initiating, by a web server, a plurality of instances of a micro-service using code associated with the at least one webpage;
performing, by the web server, a single application programming interface (API) call for a first instance in the plurality of instances, wherein a response from the single API call is shared with remaining instances in the plurality of instances;
rendering, by the web server, a plurality of web elements, corresponding to the plurality of instances, using the code and the response from the single API call; and
transmitting, to the user device, instructions for the at least one webpage including the plurality of web elements that were rendered.

9. The method of claim 8, further comprising:
transmitting, to a web host, a request for the at least one webpage; and
receiving, from the web host, the code associated with the at least one webpage.

10. The method of claim 8, wherein initiating the plurality of instances comprises:
initiating, for each web element in the plurality of web elements, a unique instance in the plurality of instances.

11. The method of claim 8, wherein the instructions for the at least one webpage comprise hypertext markup language code.

12. The method of claim 8, wherein the first instance in the plurality of instances is associated with an earliest request to an API in a queue, and the earliest request triggers the single API call.

13. The method of claim 8, wherein the request comprises a hypertext transfer protocol request.

14. The method of claim 8, further comprising:
generating a cached version of the response from the single API call; and
providing the cached version to an additional web element.

15. A non-transitory computer-readable medium storing a set of instructions for using front-end micro-services in rendering a webpage, the set of instructions comprising:
one or more instructions that, when executed by one or more processors of a device, cause the device to:
receive a request, at an application programming interface (API), from an instance of a micro-service associated with at least one webpage;
verify that the request is from the instance of the micro-service rather than from a host application associated with the at least one webpage; and
transmit a response to the instance of the micro-service based on verifying that the request is from the instance of the micro-service.

16. The non-transitory computer-readable medium of claim 15, wherein the one or more instructions, when executed by the one or more processors, cause the device to:
receive an additional request from an additional instance of the micro-service associated with the at least one webpage; and
reject the additional request based on the additional request being associated with a same micro-service as the request.

17. The non-transitory computer-readable medium of claim 15, wherein the one or more instructions, that cause the device to verify that the request is from the instance of the micro-service, cause the device to:
perform verification using a source indicated in the request.

18. The non-transitory computer-readable medium of claim 15, wherein the one or more instructions, that cause the device to verify that the request is from the instance of the micro-service, cause the device to:
perform verification using a secret code included in the request.

19. The non-transitory computer-readable medium of claim 15, wherein the response comprises an object including a plurality of elements.

20. The non-transitory computer-readable medium of claim 15, wherein the response comprises a JavaScript object notation data structure.
